(19) United States
(12) Patent Application Publication
(10) Pub. No.: US 2015/0269862 A1
(43) Pub. Date: Sep. 24, 2015

(54) METHODS AND SYSTEMS FOR PROVIDING PENMANSHIP FEEDBACK

(71) Applicant: Xerox Corporation, Norwalk, CT (US)

(72) Inventors: Eric Michael Gross, Rochester, NY (US); Eric Scott Hamby, Webster, NY (US)

(73) Assignee: Xerox Corporation, Norwalk, CT (US)

(21) Appl. No.: 14/221,791

(22) Filed: Mar. 21, 2014

(51) Int. Cl. G09B 11/00; G06K 9/00; G09B 5/00

(52) U.S. Cl. CPC G09B 11/00; G09B 5/00; G06K 9/00422

(57) ABSTRACT

A method of providing feedback to a student on penmanship may include receiving, by a computing device, a completed assessment that includes one or more handwritten responses of a student, classifying one or more of the responses into one or more classifications by applying intelligent character recognition to the responses, presenting one or more classification results to a user, receiving, by the computing device, validation information associated with the presented classification results, identifying one or more penmanship issues based, at least in part, on the received validation information, generating a second assessment that includes one or more questions designed to improve one or more of the identified penmanship issues, and providing the second assessment to the student.

### BACKGROUND

Central to the approach of digitizing education is handwriting character recognition, also referred to as Intelligent Character Recognition (ICR). ICR is commonly used to convert student's handwritten information to digital form. Once in digital form, automated grading protocols and data analytics may be performed. However, ICR classification performs relatively poorly with classification accuracies of less than 50% in some cases. This poor performance necessitates time consuming human intervention to confirm and/or correct the ICR results.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. As used herein, the term “comprising” means “including, but not limited to.”

In an embodiment, a method of providing feedback to a student on penmanship may include receiving, by a computing device, a completed assessment that includes one or more handwritten responses of a student, classifying one or more of the responses into one or more classifications by applying intelligent character recognition to the responses, presenting one or more classification results to a user, receiving, by the computing device, validation information associated with the presented classification results, identifying one or more penmanship issues based, at least in part, on the received validation information, generating a second assessment that includes one or more questions designed to improve one or more of the identified penmanship issues, and providing the second assessment to the student.

In an embodiment, a system for providing feedback to a student on penmanship may include a computing device and a computer-readable storage medium in communication with the computing device. The computer-readable storage medium may include one or more programming instructions that, when executed, cause the computing device to receive a completed assessment, classify one or more of the responses into one or more classifications by applying intelligent character recognition to the responses, present one or more classification results to a user, receive validation information associated with the presented classification results, identify one or more penmanship issues based, at least in part, on the received validation information, generate a second assessment that includes one or more questions designed to improve one or more of the identified penmanship issues, and provide the second assessment to the student. The completed assessment comprises one or more handwritten responses of a student.

### BRIEF DESCRIPTION OF THE DRAWINGS

FIG. 1 illustrates an educational assessment system according to an embodiment.

FIG. 2 illustrates a flow chart of an example method of providing feedback to a student regarding the student's penmanship according to an embodiment.

FIG. 3 illustrates a block diagram of example hardware that may be used to contain or implement program instructions according to an embodiment.

### DETAILED DESCRIPTION

The following terms shall have, for purposes of this application, the respective meanings set forth below:

An “assessment” refers to an instrument for testing one or more student skills that requires one or more handwritten answers. An assessment may be a quiz, a test, an essay, or other type of evaluation. In an embodiment, an assessment may be an instrument embodied on physical media, such as, for example, paper.

A “computing device” refers to a device that includes a processor and non-transitory, computer-readable memory. The memory may contain programming instructions that, when executed by the processor, cause the computing device to perform one or more operations according to the programming instructions. As used in this description, a “computing device” may be a single device, or any number of devices having one or more processors that communicate with each other and share data and/or instructions. Examples of computing devices include personal computers, servers, mainframes, gaming systems, televisions, and portable electronic devices such as smartphones, personal digital assistants, cameras, tablet computers, laptop computers, media players and the like.

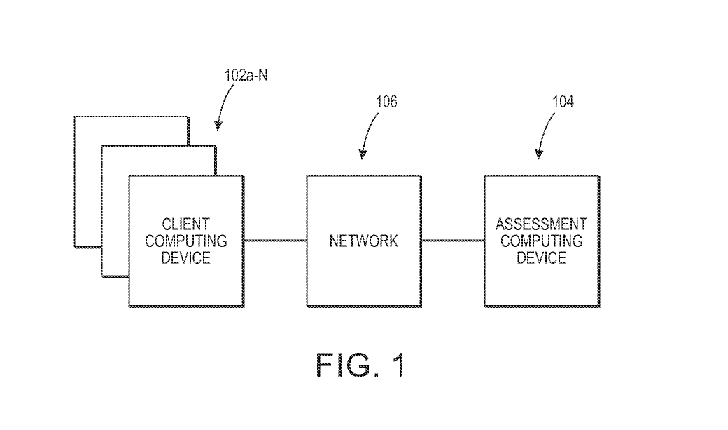

FIG. 1 illustrates an educational assessment system according to an embodiment. As illustrated by FIG. 1, an educational assessment system 100 may include one or more client computing devices 102a-N, an assessment computing device 104 and a communication network 106. As illustrated by FIG. 1, a client computing device 102a-N may communicate with an assessment computing device 104 via the communication network 106.

In an embodiment, a client computing device 102a-N may be used by an educator to access, view, change, modify, update and/or enter one or more student assessment results. A client computing device 102a-N may include, without limitation, a laptop computer, a desktop computer, a tablet, a mobile device and/or the like.

An assessment computing device 104 may be a computing device configured to receive and/or process one or more student assessments, and may include, without limitation, a laptop computer, a desktop computer, a tablet, a mobile device and/or the like.

A communication network 106 may be a local area network (LAN), a wide area network (WAN), a mobile or cellular communication network, an extranet, an intranet, the Internet and/or the like.

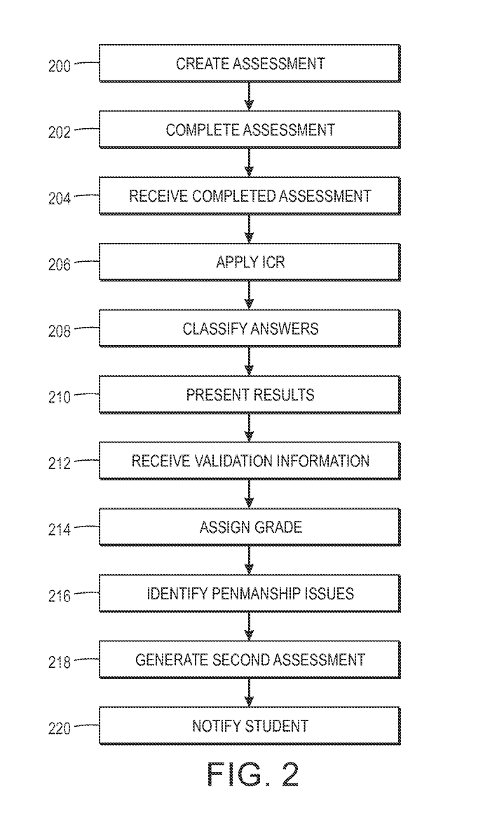

FIG. 2 illustrates a flow chart of an example method of providing feedback to a student regarding the student's penmanship according to an embodiment. As illustrated by FIG. 2, an educator may create 200 an assessment. An assessment may be created electronically by an educator. For instance, an educator may use a word processing application or other software application to create an assessment.

In an embodiment, the assessment may be provided to a student, and the student may complete 202 the assessment. A student may complete 202 at least a portion of the assessment by providing a handwritten answer for at least a portion of the assessment. For instance, an assessment may evaluate a student's math skills by asking the student to complete 202 certain mathematical equations. A student may complete 202 this assessment by writing answers to the equations on the assessment.

In an embodiment, the assessment may be provided as input to an educational assessment system. An educational assessment system may be a software application executing on or hosted by one or more computing devices that grades or otherwise evaluates one or more assessments. An educational assessment system may receive 104 a completed assessment. For instance, an educational assessment system may receive a scanned image of the completed assessment. The educational assessment system may apply 206 Intelligent Character Recognition (ICR) to a received completed assessment, and may classify 208 one or more of a student's written answers. For example, an answer may be classified 208 as “correct”, “incorrect” or “undetermined.” If the educational assessment system determines that an answer is correct, it may classify 208 the answer as “correct.” If the educational assessment system determines that an answer is incorrect, it may classify 208 the answer as “incorrect.” And if the educational assessment system determines that it cannot confirm whether an answer is correct or incorrect, it may classify 206 the answer as “undetermined.”

In another embodiment, the educational assessment system may classify an answer as that most likely determined, and may indicate, for example, by color or numerical value, a level of confidence in the accuracy of the ICR output. Additional and/or alternate classifications may be used within the scope of this disclosure.

In certain embodiments, the system may present 210 one or more results of the classification to an educator. One or more answers may be color-coded or otherwise labeled, and may be presented 210 to an educator on a display of a computing device, such as a monitor. For instance, an educational assessment system may cause answers classified as correct to be color-coded and displayed as green, cause answers that are classified as incorrect to be color-coded and displayed as red, and cause answers that are classified as underdetermined to be color-coded and displayed as yellow. Additional and/or alternate coding or labeling may be used within the scope of this disclosure.

ICR may be error prone, so one or more results may be validated to confirm their accuracy. In certain situations, an educator may manually validate classification results. For instance, an educator may review the results classified as incorrect to determine whether the answer is truly incorrect. As another example, an educator may review the results classified as undetermined to determine whether the answer is correct or incorrect.

An educator may validate one or more results by providing validation information, which may be received 212 by the educational assessment system. Validation information may include an indication of the classification to which the answer should belong. For instance, an educational assessment system may classify an answer as incorrect. However, upon review, an educator may determine that the answer is actually correct, but because of poor penmanship, the system was unable to correctly read and/or classify the response. The educator may provide validation information, which may be received 212 by the educational assessment system, that specifies that the answer is to be classified as correct.

The education assessment system may assign 214 a penmanship grade to the assessment based, at least in part, on the received validation information. The system may assign 214 a penmanship grade based on the portion of answers that are reclassified by an educator. In an embodiment, the system may assign 214 a penmanship grade based on the percentage of characters identified correctly per answer. The system may assign 214 a penmanship grade based on the portion of answers that are reclassified by an educator, or the percentage of characters identified correctly per answer.

For instance, a system may consider a measure of the answers that are classified by the system as incorrect or undetermined and then re-classified by an educator as correct in determining a penmanship grade. Table 1 illustrates example penmanship grades and corresponding example reclassification threshold levels according to an embodiment.

TABLE 1

| Percentage of Answers that are Reclassified | |
|---|---|
| as Correct by an Educator | Grade |
| 0-10% | A |
| 11-20% | B |
| 21-30% | C |
| 31-40% | D |

In an embodiment, the assigned penmanship grade may be provided as a component of the overall assessment grade. For instance, a student may be graded not only on how many questions or portions of the assessment the student answered correctly, but also on the student's penmanship. In an alternate embodiment, the assigned penmanship grade may be provided as a separate component from the overall assessment grade.

In an embodiment, an educational assessment system may identify 216 one or more penmanship issues. A penmanship issue may be an indication or poor penmanship with respect to one or more characters. One or more penmanship issues may be identified 216 based, at least in part, on the validation information. For instance, an educational assessment system may use received validation information to determine that it is incorrectly classifying a student's answers that contain the letters “d” and “g”. For example, a student may have difficulty writing the letters “d” and “g” so the student's answers that include these characters may be correct, but may be classified as incorrect by the system due to poor penmanship. Additional and/or alternate penmanship issues may be encountered within the scope of this disclosure.

In an embodiment, an educational assessment system may generate 218 a second assessment based, at least in part, on the identified penmanship issues. The system may automatically generate 218 a second assessment in response to identifying 216 one or more penmanship issues. In certain embodiments, a system may generate a second assessment in response to identifying 216 a certain number or percentage of penmanship issues. For instance, if the system identifies a number or percentage of penmanship issues that exceeds a threshold, the system may generate 218 a second assessment. As an example, if the system identifies 216 more than five penmanship issues, the system may generate 218 a second assessment. Additional and/or alternate threshold may be used within the scope of this disclosure. In certain embodiments, the threshold value may be tunable by an educator.

The generated assessment may include one or more questions or exercises to prompt the student to improve his or her penmanship with respect to one or more of the identified penmanship issues. For instance, referring to the above example, the system may generate 218 a second assessment that includes one or more questions that prompt a student to write one or more “d” characters and/or one or more “g” characters.

The system may notify 220 a student that a second assessment is ready for completion. The system may notify 220 a student by sending the student a notification such as an email message, a text message or other notification. The notification may include a hyperlink or other instructions as to how the student can access and complete the second assessment. In certain embodiments, the notification may include the second assessment to be completed and submitted by the student.

As illustrated by FIG. 2, the process may repeat and the student may complete 102 the second assessment. In an embodiment, the process may repeat until a penmanship grade exceeds a certain threshold value. For instance, a student may be asked to complete assessments until the student achieves a penmanship grade of a C or better. In various embodiments, a system may generate 218 a second assessment and/or notify 220 a student only with educator approval. As such, an educator may determine whether a second assessment should be provided to a student. Additional and/or alternate threshold values and/or grades may be used within the scope of the disclosure.

In certain embodiments, the system may generate one or more future assessments, on the same or different topic, that embed one or more difficult to classify characters for a student. The system may store or otherwise track one or more identified penmanship issues over a period of time. When a system generates an assessment for the student, the system may include one or more questions or other evaluative tools whose answers include one or more characters that were difficult for the system to classify in past assessments for the student. For instance, a student may complete an assessment for which the system has difficulty classifying the characters ‘3’ and ‘8’. When the system generates one or more future assessments for the student, the system may select one or more questions to include in the assessment that have answers that include a ‘3’, an ‘8’ or a ‘3’ and an ‘8’.

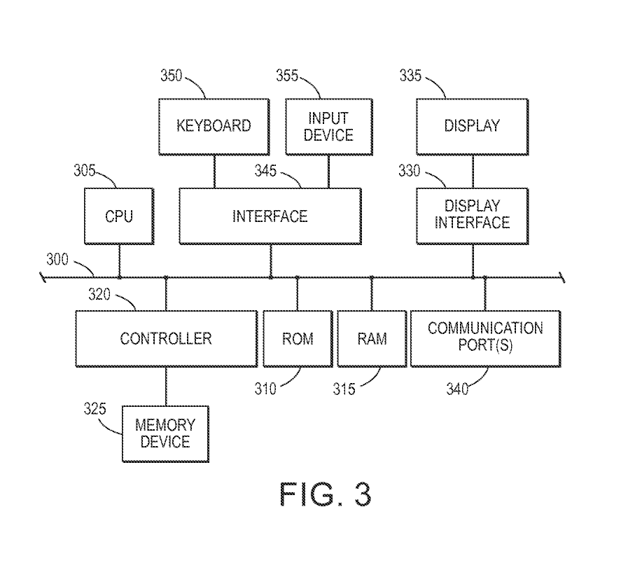

FIG. 3 depicts a block diagram of hardware that may be used to contain or implement program instructions. A bus 300 serves as the main information highway interconnecting the other illustrated components of the hardware. CPU 305 is the central processing unit of the system, performing calculations and logic operations required to execute a program. CPU 305, alone or in conjunction with one or more of the other elements disclosed in FIG. 3, is an example of a production device, computing device or processor as such terms are used within this disclosure. Read only memory (ROM) 310 and random access memory (RAM) 315 constitute examples of non-transitory computer-readable storage media.

A controller 320 interfaces with one or more optional non-transitory computer-readable storage media 325 to the system bus 300. These storage media 325 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 310 and/or the RAM 315. Optionally, the program instructions may be stored on a tangible, non-transitory computer-readable medium such as a compact disk, a digital disk, flash memory, a memory card, a USB drive, an optical disc storage medium and/or other recording medium.

An optional display interface 330 may permit information from the bus 300 to be displayed on the display 335 in audio, visual, graphic or alphanumeric format. Communication with external devices, such as a printing device, may occur using various communication ports 340. A communication port 340 may be attached to a communications network, such as the Internet or an intranet.

The hardware may also include an interface 345 which allows for receipt of data from input devices such as a keyboard 350 or other input device 355 such as a mouse, a joystick, a touch screen, a remote control, a pointing device, a video input device and/or an audio input device.

It will be appreciated that the various above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

What is claimed is:

1. A method of providing feedback to a student on penmanship, the method comprising:
receiving, by a computing device, a completed assessment, wherein the completed assessment comprises one or more handwritten responses of a student;
classifying one or more of the responses into one or more classifications by applying intelligent character recognition to the responses;
presenting one or more classification results to a user;
receiving, by the computing device, validation information associated with the presented classification results;
identifying one or more penmanship issues based, at least in part, on the received validation information;
generating a second assessment that includes one or more questions designed to improve one or more of the identified penmanship issues; and
providing the second assessment to the student.

2. The method of claim 1, wherein receiving a completed assessment comprises receiving a scanned image of a completed assessment.

3. The method of claim 1, wherein classifying one or more of the responses into one or more classifications comprises classifying one or more of the responses into one or more of the following classifications:
a correct classification;
an incorrect classification; and
an undetermined classification.

4. The method of claim 1, wherein receiving validation information associated with the presented classification results comprises receiving an indication that at least one of the responses that was classified as incorrect or undetermined should be classified as correct.

5. The method of claim 4, wherein identifying one or more penmanship issues comprises determining that the at least one response was improperly classified due to poor penmanship associated with the at least one response.

6. The method of claim 1, wherein identifying one or more penmanship issues comprises identifying one or more characters with which the student is having difficulty writing.

7. The method of claim 6, wherein generating a second assessment comprises generating a second assessment that includes one or more questions associated with answers that include one or more of the identified characters.

8. The method of claim 1, wherein generating a second assessment comprises generating a second assessment in response to receiving approval from an educator.

9. A system for providing feedback to a student on penmanship, the system comprising:
a computing device; and
a computer-readable storage medium in communication with the computing device, wherein the computer-readable storage medium comprises one or more programming instructions that, when executed, cause the computing device to:
receive a completed assessment, wherein the completed assessment comprises one or more handwritten responses of a student,
classify one or more of the responses into one or more classifications by applying intelligent character recognition to the responses,
present one or more classification results to a user,
receive validation information associated with the presented classification results,
identify one or more penmanship issues based, at least in part, on the received validation information,
generate a second assessment that includes one or more questions designed to improve one or more of the identified penmanship issues, and
provide the second assessment to the student.

10. The system of claim 9, wherein the one or more programming instructions that, when executed, cause the computing device to receive a completed assessment comprise one or more programming instructions that, when executed, cause the computing device to receive a scanned image of a completed assessment.

11. The system of claim 9, wherein the one or more programming instructions that, when executed, cause the computing device to classify one or more of the responses into one or more classifications comprise one or more programming instructions that, when executed, cause the computing device to classify one or more of the responses into one or more of the following classifications:
a correct classification;
an incorrect classification; and
an undetermined classification.

12. The system of claim 9, wherein the one or more programming instructions that, when executed, cause the computing device to receive validation information associated with the presented classification results comprise one or more programming instructions that, when executed, cause the computing device to receive an indication that at least one of the responses that was classified as incorrect or undetermined should be classified as correct.

13. The system of claim 12, wherein the one or more programming instructions that, when executed, cause the computing device to identify one or more penmanship issues comprise one or more programming instructions that, when executed, cause the computing device to determine that the at least one response was improperly classified due to poor penmanship associated with the at least one response.

14. The system of claim 9, wherein the one or more programming instructions that, when executed, cause the computing device to identify one or more penmanship issues comprise one or more programming instructions that, when executed, cause the computing device to identify one or more characters with which the student is having difficulty writing.

15. The system of claim 14, wherein the one or more programming instructions that, when executed, cause the computing device to generate a second assessment comprise one or more programming instructions that, when executed, cause the computing device to generate a second assessment that includes one or more questions associated with answers that include one or more of the identified characters.

16. The system of claim 9, wherein the one or more programming instructions that, when executed, cause the computing device to generate a second assessment comprise one or more programming instructions that, when executed, cause the computing device to generate a second assessment in response to receiving approval from an educator.
